(19) United States
(12) Patent Application Publication
(10) Pub. No.: US 2022/0299898 A1
(43) Pub. Date: Sep. 22, 2022

(54) METHOD FOR PRODUCING TONER FOR DEVELOPING ELECTROSTATIC CHARGE IMAGE, AND TONER FOR DEVELOPING ELECTROSTATIC CHARGE IMAGE

(71) Applicant: FUJIFILM Business Innovation Corp., Tokyo (JP)

(72) Inventors: Kazutsuna SASAKI, Kanagawa (JP); Daisuke NOGUCHI, Kanagawa (JP); Kazuhiko NAKAMURA, Kanagawa (JP); Hiroshi NAKAZAWA, Kanagawa (JP); Yuji ISSHIKI, Kanagawa (JP)

(73) Assignee: FUJIFILM Business Innovation Corp., Tokyo (JP)

(21) Appl. No.: 17/407,316

(22) Filed: Aug. 20, 2021

(30) Foreign Application Priority Data
Mar. 19, 2021 (JP) 2021-046476

(51) Int. Cl. G03G 9/08

(52) U.S. Cl. CPC G03G 9/0804; G03G 9/0815

(57) ABSTRACT

A method for producing a toner for developing an electrostatic charge image includes: performing first aggregation that involves aggregating at least resin particles and releasing agent particles contained in a dispersion to prepare a dispersion A containing first aggregated particles; performing second aggregation that involves adding a dispersion B containing shell resin particles to the dispersion A and aggregating the shell resin particles to form second aggregated particles; and heating and fusing the second aggregated particles to form fused particles. A total of 40 mmol or more and 190 mmol or less of a basic compound is added, per kilogram of toner particles to be obtained, from a time aggregation starts to terminate in the second aggregation to a time a temperature is elevated to a fusion temperature in the heating and fusing.

### CROSS-REFERENCE TO RELATED APPLICATIONS

This application is based on and claims priority under 35 USC 119 from Japanese Patent Application No. 2021-046476 filed Mar. 19, 2021.

### BACKGROUND

### (i) Technical Field

The present disclosure relates to a method for producing a toner for developing an electrostatic charge image, and a toner for developing an electrostatic charge image.

### (ii) Related Art

Image information visualizing methods, such as electrophotography, are presently used in various fields. In electrophotography, an electrostatic charge image is formed as image information on a surface of an image carrying body by charging and forming an electrostatic charge image. Then a toner image is formed on the surface of the image carrying body by using a developer that contains a toner, and, after the toner image is transferred onto a recording medium, the toner image is fixed onto the recording medium. Through these steps, image information is visualized into an image.

For example, Japanese Unexamined Patent Application Publication No. 2013-25093 discloses a method for producing a toner for electrophotography, the method including the following steps (1) to (3):

Step (1): a step of fusion-bonding aggregated particles in an aqueous mixture solution after and/or while the pH of the aqueous mixture solution at 25° C. is adjusted to 2.0 to 5.0, the aqueous mixture solution containing a surfactant and the aggregated particles that contain resin particles (A) and releasing agent particles.

Step (2): a step of adjusting the pH at 25° C. of the fusion-bonded particle dispersion obtained in step (1) to 5.5 to 7.5.

Step (3): a step of removing the liquid portion from the fusion-bonded particle dispersion obtained in step (2) so as to obtain toner particles.

### SUMMARY

Aspects of non-limiting embodiments of the present disclosure relate to a method for producing a toner for developing an electrostatic charge image, the toner having a narrower particle size distribution compared to when the toner is produced by performing first aggregation that involves aggregating at least resin particles and releasing agent particles contained in a dispersion to prepare a dispersion A containing first aggregated particles; performing second aggregation that involves adding a dispersion B containing shell resin particles to the dispersion A and aggregating the shell resin particles to form second aggregated particles; and heating and fusing the second aggregated particles to form fused particles, in which a total of less than 40 mmol or more than 190 mmol or less of a basic compound is added, per kilogram of toner particles to be obtained, from a time aggregation starts to terminate in the second aggregation to a time a temperature is elevated to a fusion temperature in the heating and fusing.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a method for producing a toner for developing an electrostatic charge image, the method including: performing first aggregation that involves aggregating at least resin particles and releasing agent particles contained in a dispersion to prepare a dispersion A containing first aggregated particles; performing second aggregation that involves adding a dispersion B containing shell resin particles to the dispersion A and aggregating the shell resin particles to form second aggregated particles; and heating and fusing the second aggregated particles to form fused particles, in which a total of 40 mmol or more and 190 mmol or less of a basic compound is added, per kilogram of toner particles to be obtained, from a time aggregation starts to terminate in the second aggregation to a time a temperature is elevated to a fusion temperature in the heating and fusing.

### BRIEF DESCRIPTION OF THE DRAWINGS

Exemplary embodiments of the present disclosure will be described in detail based on the following figures, wherein:

FIG. 1 is a schematic diagram illustrating one example of an image forming apparatus according to an exemplary embodiment; and

FIG. 2 is a schematic diagram illustrating one example of a process cartridge according to an exemplary embodiment.

### DETAILED DESCRIPTION

Hereinafter, exemplary embodiments, which are some examples of the present disclosure, are described in detail.

When numerical ranges are described stepwise, the upper limit or the lower limit of one numerical range may be substituted with an upper limit or a lower limit of a different numerical range also described stepwise.

In any numerical range, the upper limit or the lower limit of the numerical range may be substituted with a value indicated in Examples.

When multiple substances that correspond to a particular component in a composition are present in the composition, the amount of that component in the composition is the total amount of the multiple substances present in the composition unless otherwise noted.

The term “step” refers not only to an independent step but also to any feature that attains the intended purpose of the step even if this feature is not clearly distinguishable from other steps.

### Method for Producing Toner for Developing Electrostatic Charge Image

A method for producing a toner for developing an electrostatic charge image according to an exemplary embodiment includes a first aggregation step that involves aggregating at least resin particles and releasing agent particles contained in a dispersion to prepare a dispersion A containing first aggregated particles; a second aggregation step that involves adding a dispersion B containing shell resin particles to the dispersion A and aggregating the shell resin particles to form second aggregated particles; and a fusing step of heating and fusing the second aggregated particles to form fused particles. In this method, a total of 40 mmol or more and 190 mmol or less of a basic compound is added, per kilogram of toner particles to be obtained, from a time aggregation starts to terminate in the second aggregation to a time a temperature is elevated to a fusion temperature in the heating and fusing.

A toner for developing an electrostatic charge image according to an exemplary embodiment is a toner produced by the method for producing the toner for developing an electrostatic charge image of the aforementioned exemplary embodiment.

There is known a method for producing a toner by emulsion polymerization in order to narrow the particle size distribution and obtain good charge properties, the method involving aggregating resin particles etc., in a water-based medium by using an aggregating agent containing a metal ion, terminating the aggregation, and then fusion-bonding the aggregated particles. In obtaining a toner by fusion-bonding after termination of the aggregation of the aggregated particles by using a chelating agent or an alkaline aqueous solution in this emulsion polymerization method, there have been cases where some of the metal ions have remained on the toner surfaces, leading to a wide particle size distribution.

In the method for producing a toner for developing an electrostatic charge image according to this exemplary embodiment, the total amount of the basic compound added from the time aggregation starts to terminate in the second aggregation step to the time the temperature is elevated to the fusion temperature in the fusing step is 40 mmol or more and 190 mmol or less per kilogram of toner particles to be obtained. Presumably due to this feature, the amount of the metal ions on the toner particle surfaces is controlled, the repulsion between the resin particles and between the releasing agent particles is controlled, and therefore generation of aggregation lumps is suppressed and the particle size distribution of the obtained toner becomes narrow.

### Addition of Basic Compound

In the method for producing a toner for developing an electrostatic charge image according to this exemplary embodiment, the total amount of the basic compound added from the time aggregation starts to terminate in the second aggregation step to the time the temperature is elevated to the fusion temperature in the fusing step is 40 mmol or more and 190 mmol or less per kilogram of toner particles to be obtained. From the viewpoints of particle size distribution, a property of suppressing generation of coarse particles, and a property of suppressing image defects, this total amount is preferably 60 mmol or more and 180 mmol or less, more preferably 80 mmol or more and 160 mmol or less, and yet more preferably 80 mmol or more and 140 mmol or less.

In this exemplary embodiment, the “time aggregation starts to terminate in the second aggregation step” refers to the time when the pH starts to change due to addition of the basic compound or the time when the dispersion containing the second aggregated particles is cooled and the temperature starts to decrease from the aggregation temperature.

In the exemplary embodiment, the “time the temperature is elevated to the fusion temperature in the fusing step” is the time when the temperature reaches the temperature of performing fusion in the fusing step and the change in temperature of the dispersion is 1° C./minute or less.

Specific examples of the basic compound include hydroxides of alkali metals such as lithium, sodium, and potassium, oxides and hydroxides of alkaline earth metals such as magnesium and calcium, ammonia, and amine compounds. Among these, hydroxides of alkali metals and alkaline earth metals are preferable, hydroxides of alkali metals are more preferable, potassium hydroxide and sodium hydroxide are yet more preferable, and sodium hydroxide is particularly preferable from the viewpoints of fixability and transferability of the toner to be obtained.

The basic compound is preferably added by preparing a water-based medium solution of the basic compound and more preferably by preparing an aqueous solution of the basic compound. Examples of the water-based medium are described below.

When the pH of the dispersion upon termination of the aggregation in the second aggregation step is represented by pH(A) and the pH of the dispersion upon elevation of the temperature to the fusion temperature in the fusing step is represented by pH(B), pH(B)−pH(A) is preferably more than 0 and less than 3, more preferably more than 0 and less than 2, and particularly preferably more than 0 and less than 1 from the viewpoints of the particle size distribution, the property of suppressing generation of coarse particles, and the property of suppressing image defects.

The pH(A) in the second aggregation step is preferably 6.0 or more and 9.0 or less, more preferably 6.5 or more and 8.5 or less, and yet more preferably 7.0 or more and 8.0 or less from the viewpoints of the particle size distribution, the property of suppressing generation of coarse particles, and the property of suppressing image defects.

The pH(B) in the fusing step is preferably 7.0 or more and 9.5 or less, more preferably 7.5 or more and 9.0 or less, and yet more preferably 7.5 or more and 8.5 or less from the viewpoints of the particle size distribution, the property of suppressing generation of coarse particles, and the property of suppressing image defects.

From the viewpoints of the particle size distribution, the property of suppressing generation of coarse particles, and the property of suppressing image defects, the basic compound is preferably added at least once, more preferably added once to three times, and yet more preferably added once or twice when terminating the aggregation in the second aggregation step.

Moreover, from the viewpoints of the particle size distribution, the property of suppressing generation of coarse particles, and the property of suppressing image defects, the basic compound is preferably added at least once, more preferably added at least twice, yet more preferably added twice to five times, and particularly preferably added three or four times when elevating the temperature in the fusing step.

Furthermore, from the viewpoints of the particle size distribution, the property of suppressing generation of coarse particles, and the property of suppressing image defects, the basic compound is preferably added at least once when terminating the aggregation in the second aggregation step and the basic compound is added at least once when elevating the temperature in the fusing step.

The amount of the basic compound added when terminating aggregation in the second aggregation step is 10 mmol or more and 180 mmol or less, more preferably 20 mmol or more and 140 mmol or less, and yet more preferably 30 mmol or more and 120 mmol or less per kilogram of toner particles to be obtained from the viewpoints of the particle size distribution, the property of suppressing generation of coarse particles, and the property of suppressing image defects.

Furthermore, the amount of the basic compound added when elevating the temperature in the fusing step is preferably 10 mmol or more and 180 mmol or less, more preferably 15 mmol or more and 160 mmol or less, and yet more preferably 20 mmol or more and 140 mmol or less per kilogram of toner particles to be obtained from the viewpoints of the particle size distribution, the property of suppressing generation of coarse particles, and the property of suppressing image defects.

Furthermore, from the viewpoints of the particle size distribution, the property of suppressing generation of coarse particles, and the property of suppressing image defects, the amount of the basic compound added when elevating the temperature in the fusing step can be smaller than the amount of the basic compound added when terminating the aggregation in the second aggregation.

The method for producing a toner for developing an electrostatic charge image according to this exemplary embodiment involves forming toner particles by an aggregation and coalescence method.

Hereinafter, steps other than those described above are described in detail.

### First Aggregation Step

The method for producing a toner for developing an electrostatic charge image according to this exemplary embodiment includes a first aggregation step of aggregating at least resin particles and releasing agent particles contained in a dispersion to prepare a dispersion A containing first aggregated particles.

The dispersion in the first aggregation step contains at least the resin particles and the releasing agent particles. If needed, the dispersion may further contain coloring agent particles and the like.

The method for preparing the dispersion is not particularly limited, and, for example, the dispersion can be prepared by mixing a resin particle dispersion and a releasing agent particle dispersion.

In the dispersion, at least the resin particles and the releasing agent particles are aggregated to prepare a dispersion A containing first aggregated particles.

Specifically, for example, aggregation involves adding an aggregating agent to the dispersion, adjusting the pH of the dispersion to acidic (for example, a pH of 2 or more and 5 or less), adding a dispersion stabilizer as needed, and heating the resulting mixture to a temperature corresponding to the glass transition temperature of the resin particles (specifically, for example, a temperature 30° C. to 10° C. lower than the glass transition temperature of the resin particles) to aggregate the particles dispersed in the dispersion and to thereby form first aggregated particles.

In the first aggregation step, for example, while the dispersion is stirred with a rotary shear homogenizer, the aggregating agent may be added to the dispersion at room temperature (for example, 25° C.) to adjust the pH of the dispersion to acidic (for example, a pH of 2 or more and 5 or less), and the heating may be performed after a dispersion stabilizer is added as needed.

Examples of the aggregating agent include a surfactant having an opposite polarity to a surfactant used as a dispersing agent added to the mixed dispersion, an inorganic metal salt, and a divalent or higher metal complex. In particular, when a metal complex is used as the aggregating agent, the amount of the surfactant used is decreased, and the charge properties are improved.

An additive that forms a complex or a similar bond to the metal ion in the aggregating agent may be used as needed. For example, a chelating agent can be used as this additive.

Examples of the inorganic metal salt include metal salts such as calcium chloride, calcium nitrate, barium chloride, magnesium chloride, zinc chloride, aluminum chloride, and aluminum sulfate, and inorganic metal salt polymers such as polyaluminum chloride, polyaluminum hydroxide, and calcium polysulfide.

Among these, an aluminum compound can be used as the aggregating agent.

A water-soluble chelating agent may be used as the chelating agent. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent added is, for example, preferably 0.01 parts by mass or more and 5.0 parts by mass or less and more preferably 0.1 parts by mass or more and less than 3.0 parts by mass relative to 100 parts by mass of the resin particles.

The dispersion and the dispersion A in the first aggregation step are preferably water-based dispersions and are more preferably water dispersions.

Examples of the dispersion medium used in the dispersion and the dispersion A in the first aggregation step include water-based media. Examples of the water-based media include water such as distilled water and ion exchange water, and alcohols. These may be used alone or in combination.

The dispersion in the first aggregation step can contain a surfactant.

Examples of the surfactant include anionic surfactants such as sulfate surfactants, sulfonate surfactants, phosphate surfactants, and soap surfactants; cationic surfactants such as amine salt surfactants and quaternary ammonium salt surfactants; and nonionic surfactants such as polyethylene glycol surfactants, alkyl phenol ethylene oxide adduct surfactants, and polyhydric alcohol surfactants. Among these, an anionic surfactant and a cationic surfactant are preferable. A nonionic surfactant may be used in combination with an anionic surfactant or a cationic surfactant.

These surfactants may be used alone or in combination.

The volume average particle diameter of the resin particles before aggregation dispersed in the dispersion is preferably 0.01 μm or more and 1 μm or less, more preferably 0.08 μm or more and 0.8 μm or less, and yet more preferably 0.1 μm or more and 0.6 μm or less.

The volume average particle diameter of the releasing agent particles before aggregation dispersed in the dispersion is preferably 0.01 μm or more and 1 μm or less, more preferably 0.08 μm or more and 0.8 μm or less, and yet more preferably 0.1 μm or more and 0.6 μm or less.

The volume average particle diameters of the resin particles and the releasing agent particles are each determined by using a particle size distribution obtained by measurement with a laser diffraction particle size distribution meter (for example, LA-700 produced by Horiba Ltd.), drawing a cumulative distribution with respect to volume from the small diameter size relative to the divided particle size ranges (channels), and assuming the particle diameter at 50% accumulation relative to all particles as D50v. The volume average particle diameters of other particles in the dispersion are also measured in a similar manner.

The resin particles in the first aggregation step preferably contain polyester resin particles and more preferably are polyester resin particles from the viewpoints of the property of suppressing the surface exposure of the releasing agent, the thermal storage property, and the image density stability.

The resin particles in the first aggregation step preferably contain amorphous resin particles and more preferably contain amorphous resin particles and crystalline resin particles.

As described above, the dispersion may further contain coloring agent particles used in the toner particles, and the like.

The volume average particle diameter of the coloring agent particles may be the same as that of the resin particles.

In the first aggregation step, from the viewpoint of the dispersibility of the resin particles, the releasing agent particles, etc., the solid component concentration of the dispersion is preferably 5 mass % or more and 30 mass % or less, more preferably 8 mass % or more and 25 mass % or less, and yet more preferably 11 mass % or more and 20 mass % or less.

The volume average particle diameter of the aggregated particles obtained in the aforementioned aggregation step is not particularly limited, and can be appropriately selected according to the intended volume average particle diameter of the toner particles.

The individual components, such as a binder resin, a releasing agent, and a coloring agent, contained in the toner particles are described below.

### Second Aggregation Step

The method for producing a toner for developing an electrostatic charge image according to this exemplary embodiment includes a second aggregation step of adding a dispersion B containing shell resin particles to the dispersion A and aggregating the shell resin particles to form second aggregated particles.

In the second aggregation step, the dispersion A containing the first aggregated particles is mixed with a shell resin particle dispersion.

Then the shell resin particles are allowed to aggregate onto the surfaces of the first aggregated particles to form second aggregated particles.

Specifically, the aggregation in the second aggregation step involves, for example, adding a dispersion stabilizer as needed, and then heating the dispersion to a temperature equal to the glass transition temperature of the shell resin particles (specifically, for example, a temperature equal to or lower than the glass transition temperature of the shell resin particles) to aggregate the shell resin particles on the surfaces of the first aggregated particles and to thereby form second aggregated particles.

Next, the pH of the dispersion containing the second aggregated particles is adjusted to terminate the progress of the aggregation.

In the second aggregation step, for example, while the dispersion A is stirred with a rotary shear homogenizer, the heating may be performed after adding a dispersion stabilizer as needed at room temperature (for example, 25° C.)

In addition, in the second aggregation step, an aggregating agent may be added; however, from the viewpoint of the uniformity of aggregation, addition of the aggregating agent can be omitted.

The value of the mass ratio (M(A)/M(B)) of the mass M(A) of the first aggregated particles used in the second aggregation step and the mass M(B) of the shell resin particles is preferably 2 or more and 10 or less, more preferably 2.5 or more and 8 or less, and yet more preferably 3 or more and 5 or less from the viewpoints of the property of suppressing the surface exposure of the releasing agent, the thermal storage property, and the image density stability.

The shell resin particles in the second aggregation step preferably contain polyester resin particles and more preferably are polyester resin particles from the viewpoints of the property of suppressing the surface exposure of the releasing agent, the thermal storage property, and the image density stability.

The dispersion B in the second aggregation step is preferably a water-based dispersion and is more preferably a water dispersion.

### Fusing Step

The method for producing a toner for developing an electrostatic charge image according to this exemplary embodiment includes a fusing step of heating and fusing the second aggregated particles to form fused particles.

In the fusing step, a dispersion containing the second aggregated particles dispersed therein are heated to a temperature equal to or higher than the glass transition temperatures of the resin particles and the shell resin particles (for example, a temperature 30° C. to 50° C. higher than the glass transition temperatures of the resin particles and the shell resin particles) and equal to or higher than the melting temperature of the releasing agent so as to fuse and coalesce the second aggregated particles to thereby form toner particles.

In the fusing step, the resin and the releasing agent are in a compatibilized state at a temperature equal to or higher than the glass transition temperatures of the resin particles and the shell resin particles and equal to or higher than the melting temperature of the releasing agent. Subsequently, the resulting product is cooled to obtain toner particles.

Core-shell toner particles are obtained through the aforementioned steps.

Here, upon completion of the fusing step, the toner particles formed in the solution are subjected to a known washing step, a known solid-liquid separation step, and a known drying step to obtain dry toner particles.

The washing step may involve thorough substitution washing with ion exchange water from the standpoint of chargeability. The solid-liquid separation step is not particularly limited but can involve suction filtration, pressure filtration, or the like from the viewpoint of productivity. Although the drying step is also not particularly limited, from the viewpoint of productivity, freeze drying, air drying, flow drying, vibration flow drying, or the like can be employed.

The method for producing a toner for developing an electrostatic charge image according to this exemplary embodiment can include a step of externally adding an external additive to the obtained toner particles.

The external addition method may use a V blender, a HENSCHEL mixer, a Lodige mixer, or the like, for example. Furthermore, if necessary, coarse particles in the toner may be removed by using a vibrating sieving machine, an air sieving machine, or the like.

### Resin Particle Dispersion Preparation Step

The method for producing a toner for developing an electrostatic charge image according to this exemplary embodiment can include a resin particle dispersion preparation step of preparing a resin particle dispersion.

The method for producing a toner for developing an electrostatic charge image according to this exemplary embodiment can include a step of preparing a coloring agent particle dispersion containing dispersed coloring agent particles and a step of preparing a releasing agent particle dispersion containing dispersed releasing agent particles in addition to the step of preparing the resin particle dispersion containing dispersed resin particles.

The resin particle dispersion is prepared by, for example, dispersing resin particles in a dispersion medium by using a surfactant.

Examples of the dispersion medium used in the resin particle dispersion include water-based media.

Examples of the water-based media include water such as distilled water and ion exchange water, and alcohols. These may be used alone or in combination.

Examples of the surfactant include anionic surfactants such as sulfate surfactants, sulfonate surfactants, phosphate surfactants, and soap surfactants; cationic surfactants such as amine salt surfactants and quaternary ammonium salt surfactants; and nonionic surfactants such as polyethylene glycol surfactants, alkyl phenol ethylene oxide adduct surfactants, and polyhydric alcohol surfactants. Among these, an anionic surfactant and a cationic surfactant are preferable. A nonionic surfactant may be used in combination with an anionic surfactant or a cationic surfactant.

These surfactants may be used alone or in combination.

Examples of the method for dispersing resin particles in a dispersion medium in preparing the resin particle dispersion include typical dispersing methods that use a rotary shear homogenizer, a ball mill having media, a sand mill, a dyno mill, etc. Depending on the type of the resin particles, the resin particles may be dispersed in a dispersion medium by a phase inversion emulsification method. The phase inversion emulsification method is a method that involves dissolving a resin to be dispersed in a hydrophobic organic solvent that can dissolve the resin, adding a base to the organic continuous phase (O phase) to neutralize, and adding a water-based medium (W phase) to the resulting product to perform W/O-to-O/W phase inversion and disperse particles of the resin in the water-based medium.

The volume average particle diameter of the resin particles to be dispersed in the resin particle dispersion is preferably 0.01 μm or more and 1 μm or less, more preferably 0.08 μm or more and 0.8 μm or less, and yet more preferably 0.1 μm or more and 0.6 μm or less.

The amount of the resin particles contained in the resin particle dispersion is preferably 5 mass % or more and 50 mass % or less and more preferably 10 mass % or more and 40 mass % or less.

The coloring agent particle dispersion and the releasing agent particle dispersion can also be prepared in the same manner as the resin particle dispersion. In other words, the volume average particle diameter, the dispersion medium, the dispersing method, and the amount of particles of the particles in the resin particle dispersion equally apply to the coloring agent particles to be dispersed in the coloring agent dispersion and the releasing agent particles to be dispersed in the releasing agent dispersion.

The method for producing a toner for developing an electrostatic charge image according to this exemplary embodiment can further include any known steps other than those described above.

Hereinafter, the respective components in the toner for developing an electrostatic charge image are described in detail.

The toner particles contain a binder resin, a releasing agent, and, if necessary, other components, but can contain a binder resin, a releasing agent, and a coloring agent.

### Binder Resin

The binder resin preferably contains an amorphous resin and more preferably contains an amorphous resin and a crystalline resin from the viewpoints of the image strength and suppression of density nonuniformity in the obtained image. In other words, in the first aggregation step, amorphous resin particles and crystalline resin particles can be contained as the resin particles.

Here, an amorphous resin refers to a resin that exhibits only a stepwise endothermic change rather than a clear endothermic peak in thermal analysis by differential scanning calorimetry (DSC), that is solid at room temperature, and that turns thermoplastic at a temperature equal to or higher than the glass transition temperature.

In contrast, a crystalline resin refers to a resin that has a clear endothermic peak rather than a stepwise endothermic change in differential scanning calorimetry (DSC).

Specifically, for example, a crystalline resin refers to a resin that has an endothermic peak having a half width of 10° C. or less when measured at a heating rate of 10° C./min, and an amorphous resin refers to a resin that has a half width exceeding 10° C. or has no clear endothermic peak.

The amorphous resin will now be described.

Examples of the amorphous resin include known amorphous resins such as amorphous polyester resins, amorphous vinyl resins (for example, styrene acrylic resin), epoxy resins, polycarbonate resins, and polyurethane resins. Among these, amorphous polyester resins and amorphous vinyl resins (in particular, styrene acrylic resins) are preferable and amorphous polyester resins are more preferable from the viewpoints of suppressing density nonuniformity and voids in the obtained image.

An amorphous polyester resin and a styrene acrylic resin can be used in combination as the amorphous resin.

Examples of the amorphous polyester resins include polycondensation products between polycarboxylic acids and polyhydric alcohols. A commercially available amorphous polyester resin or a synthesized amorphous polyester resin may be used as the amorphous polyester resin.

Examples of the polycarboxylic acids include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, and sebacic acid), alicyclic dicarboxylic acids (for example, cyclohexanedicarboxylic acid), aromatic dicarboxylic acids (for example, terephthalic acid, isophthalic acid, phthalic acid, and naphthalenedicarboxylic acid), anhydrides thereof, and lower (for example, 1 to 5 carbon atoms) alkyl esters thereof. Among these, aromatic dicarboxylic acids can be used as polycarboxylic acids.

A dicarboxylic acid and a tri- or higher carboxylic acid having a crosslinked structure or a branched structure may be used in combination as the polycarboxylic acid. Examples of the tri- or higher carboxylic acid include trimellitic acid, pyromellitic acid, anhydrides thereof, and lower(for example, 1 to 5 carbon atoms) alkyl esters thereof.

These polycarboxylic acids may be used alone or in combination.

Examples of the polyhydric alcohols include aliphatic diols (for example, ethylene glycol, diethylene glycol, triethylene glycol, propylene glycol, butanediol, hexanediol, and neopentyl glycol), alicyclic diols (for example, cyclohexanediol, cyclohexanedimethanol, and hydrogenated bisphenol A), and aromatic diols (for example, ethylene oxide adducts of bisphenol A and propylene oxide adducts of bisphenol A). Among these, aromatic diols and alicyclic diols are preferred, and aromatic diols are more preferred as the polyhydric alcohols.

A trihydric or higher alcohol having a crosslinked structure or a branched structure may be used in combination with a diol as the polyhydric alcohol. Examples of the trihydric or higher alcohol include glycerin, trimethylolpropane, and pentaerythritol.

These polyhydric alcohols may be used alone or in combination.

The amorphous polyester resin is obtained by a known production method. Specifically, the amorphous polyester resin is obtained by a method that involves, for example, setting the polymerization temperature to 180° C. or higher and 230° C. or lower, depressurizing the inside of the reaction system as necessary, and performing reaction while removing water and alcohol generated during the condensation. When the monomers of the raw materials do not dissolve or mix at the reaction temperature, a high-boiling-point solvent may be added as a dissolving aid. In such a case, the polycondensation reaction is performed while distilling away the dissolving aid. In the copolymerization reaction, when a poorly compatible monomer is present, that monomer may be subjected to condensation with an acid or alcohol for the condensation in advance, and then subjected to polycondensation with other component.

An example of the binder resin, in particular, the amorphous resin, is a styrene acrylic resin.

A styrene acrylic resin is a copolymer obtained by copolymerizing at least a styrene monomer (a monomer having a styrene skeleton) and a (meth)acrylic monomer (a monomer having a (meth)acryl group, preferably, a monomer having a (meth)acryloxy group). The styrene acrylic resin includes, for example, a copolymer of a styrene monomer and a (meth)acrylate monomer.

The acrylic resin moiety in the styrene acrylic resin is a partial structure obtained by polymerizing one or both of an acrylic monomer and a methacrylic monomer. The term “(meth)acryl” includes both acryl and methacryl.

Specific examples of the styrene monomer include styrene, alkyl-substituted styrene (for example, α-methylstyrene, 2-methylstyrene, 3-methylstyrene, 4-methylstyrene, 2-ethylstyrene, 3-ethylstyrene, and 4-ethylstyrene), halogen-substituted styrene (for example, 2-chlorostyrene, 3-chlorostyrene, and 4-chlorostyrene), and vinylnaphthalene. These styrene monomers may be used alone or in combination.

Among these, styrene can be used as the styrene monomer from the viewpoints of ease of reaction, ease of controlling the reaction, and availability.

Specific examples of the (meth)acryl monomer include (meth)acrylic acid and (meth)acrylate. Examples of the (meth)acrylate include (meth)acrylic acid alkyl esters (for example, methyl (meth)acrylate, ethyl (meth)acrylate, n-propyl (meth)acrylate, n-butyl (meth)acrylate, n-pentyl (meth)acrylate, n-hexyl acrylate, n-heptyl (meth)acrylate, n-octyl (meth)acrylate, n-decyl (meth)acrylate, n-dodecyl (meth) acrylate, n-lauryl (meth) acrylate, n-tetradecyl (meth) acrylate, n-hexadecyl (meth) acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth) acrylate, isooctyl (meth) acrylate, 2-ethylhexyl (meth)acrylate, cyclohexyl (meth)acrylate, and t-butylcyclohexyl (meth)acrylate), (meth)acrylic acid aryl esters (for example, phenyl (meth)acrylate, biphenyl (meth) acrylate, diphenylethyl (meth) acrylate, t-butylphenyl (meth)acrylate, and terphenyl (meth)acrylate), dimethylaminoethyl (meth) acrylate, diethylaminoethyl (meth) acrylate, methoxyethyl (meth) acrylate, 2-hydroxyethyl (meth)acrylate, β-carboxyethyl (meth)acrylate, and (meth)acrylamide. These (meth)acrylate monomers may be used alone or in combination.

Among these (meth)acrylates serving as the (meth)acryl monomers, (meth)acrylates having an alkyl group having 2 to 14 carbon atoms (preferably 2 to 10 carbon atoms and more preferably 3 to 8 carbon atoms) are preferable from the viewpoint of fixability.

Among these, n-butyl (meth)acrylate is preferable, and n-butyl acrylate is particularly preferable.

The copolymerization ratio of the styrene monomer to the (meth)acryl monomer (mass basis, styrene monomer/(meth)acryl monomer) is not particularly limited and can be 85/15 to 70/30.

The styrene acrylic resin may have a crosslinked structure. An example of the styrene acrylic resin having a crosslinked structure is a resin obtained by copolymerizing at least a styrene monomer, a (meth)acrylic acid monomer, and a crosslinking monomer.

Examples of the crosslinking monomer include difunctional or higher crosslinking agents.

Examples of the difunctional crosslinking agent include divinylbenzene, divinylnaphthalene, di(meth)acrylate compounds (for example, diethylene glycol di(meth)acrylate, methylenebis(meth)acrylamide, decanediol diacrylate, and glycidyl (meth)acrylate), polyester-type di(meth)acrylate, 2-([1′-methylpropylideneamino]carboxyamino)ethyl methacrylate.

Examples of the polyfunctional crosslinking agent include tri(meth)acrylate compounds (for example, pentaerythritol tri(meth)acrylate, trimethylolethane tri(meth)acrylate, and trimethylolpropane tri(meth)acrylate), tetra(meth)acrylate compounds (for example, pentaerythritol tetra(meth)acrylate and oligo ester (meth) acrylate), 2,2-bis(4-methacryloxy, polyethoxyphenyl)propane, diallyl phthalate, triallyl cyanurate, triallyl isocyanurate, triallyl trimellitate, and diallyl chlorendate.

In particular, from the viewpoints of suppressing degradation of the image density and image density nonuniformity, and fixability, the crosslinking monomer is preferably a difunctional or higher (meth)acrylate compound, more preferably a difunctional (meth)acrylate compound, yet more preferably a difunctional (meth)acrylate compound having an alkylene group having 6 to 20 carbon atoms, and particularly preferably a difunctional (meth)acrylate compound having a linear alkylene group having 6 to 20 carbon atoms.

The copolymerization ratio of the crosslinking monomer relative to all monomers (mass basis, crosslinking monomer/all monomers) is not particularly limited and can be 2/1,000 to 20/1,000.

The method for preparing the styrene acrylic resin is not particularly limited, and various polymerization methods (for example, solution polymerization, precipitation polymerization, suspension polymerization, bulk polymerization, and emulsification polymerization) are applied. Known processes (for example, batch, semi-continuous, and continuous methods) are applied to the polymerization reaction.

The styrene acrylic resin preferably accounts for 0 mass % or more and 20 mass % or less, more preferably 1 mass % or more and 15 mass % or less, and yet more preferably 2 mass % or more and 10 mass % or less of the entire binder resin.

The amorphous resin preferably accounts for 60 mass % or more and 98 mass % or less, more preferably 65 mass % or more and 95 mass % or less, and yet more preferably 70 mass % or more and 90 mass % or less of the entire binder resin.

The properties of the amorphous resin will now be described.

The glass transition temperature (Tg) of the amorphous resin is preferably 50° C. or higher and 80° C. or lower and more preferably 50° C. or higher and 65° C. or lower.

The glass transition temperature is determined from a DSC curve obtained by differential scanning calorimetry (DSC), more specifically, according to “extrapolated glass transition onset temperature” described in the method for determining the glass transition temperature in JIS K 7121:1987 “Testing Methods for Transition Temperatures of Plastics”.

The weight average molecular weight (Mw) of the amorphous resin is preferably 5,000 or more and 1,000,000 or less and more preferably 7,000 or more and 500,000 or less.

The number average molecular weight (Mn) of the amorphous resin can be 2,000 or more and 100,000 or less.

The molecular weight distribution Mw/Mn of the amorphous resin is preferably 1.5 or more and 100 or less and more preferably 2 or more and 60 or less.

The weight average molecular weight and the number average molecular weight are measured by gel permeation chromatography (GPC). The molecular weight measurement by GPC is conducted by using GPCHLC-8120GPC produced by TOSOH CORPORATION as a measuring instrument with columns, TSKgel Super HM-M (15 cm) produced by TOSOH CORPORATION, and a THF solvent. The weight average molecular weight and the number average molecular weight are calculated from the measurement results by using the molecular weight calibration curves obtained from monodisperse polystyrene standard samples.

The crystalline resin will now be described.

Examples of the crystalline resin include known crystalline resins such as a crystalline polyester resin and a crystalline vinyl resin (for example, a polyalkylene resin and a long alkyl (meth)acrylate resin). Among these, from the viewpoints of suppressing density nonuniformity and voids in the obtained image, a crystalline polyester resin can be used.

Examples of the crystalline polyester resin include polycondensation products between polycarboxylic acids and polyhydric alcohols. A commercially available crystalline polyester resin or a synthesized crystalline polyester resin may be used as the crystalline polyester resin.

To smoothly form a crystal structure, the crystalline polyester resin can be a polycondensation product obtained by using a linear aliphatic polymerizable monomer rather than a polymerizable monomer having an aromatic ring.

Examples of the polycarboxylic acids include aliphatic dicarboxylic acids (for example, oxalic acid, succinic acid, glutaric acid, adipic acid, suberic acid, azelaic acid, sebacic acid, 1,9-nonandicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (for example, dibasic acids such as phthalic acid, isophthalic acid, terephthalic acid, and naphthalene-2,6-dicarboxylic acid), anhydrides thereof, and lower (for example, 1 to 5 carbon atoms) alkyl esters thereof.

A dicarboxylic acid and a tri- or higher carboxylic acid having a crosslinked structure or a branched structure may be used in combination as the polycarboxylic acid. Examples of the tricarboxylic acid include aromatic carboxylic acids (for example, 1,2,3-benzenetricarboxylic acid, 1,2,4-benzenetricarboxylic acid, and 1,2,4-naphthalenetricarboxylic acid), anhydrides thereof, and lower(for example, 1 to 5 carbon atoms) alkyl esters thereof.

Together with these dicarboxylic acids, a dicarboxylic acid having a sulfonic acid group and a dicarboxylic acid having an ethylenic double bond may be used in combination.

These polycarboxylic acids may be used alone or in combination.

Examples of the polyhydric alcohol include aliphatic diols (for example, linear aliphatic diols having a main chain moiety having 7 to 20 carbon atoms). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among these, 1,8-octanediol, 1,9-nonanediol, and 1,10-decanediol are preferable as the aliphatic diol.

A trihydric or higher alcohol having a crosslinked structure or a branched structure may be used in combination with a diol in the polyhydric alcohol. Examples of the trihydric or higher alcohol include glycerin, trimethylolethane, trimethylolpropane, and pentaerythritol.

These polyhydric alcohols may be used alone or in combination.

The polyhydric alcohol preferably contains 80 mol % or more and more preferably 90 mol % or more of the aliphatic diol.

The melting temperature of the crystalline polyester resin is preferably 50° C. or higher and 100° C. or lower, more preferably 55° C. or higher and 90° C. or lower, and yet more preferably 60° C. or higher and 85° C. or lower.

The melting temperature of the crystalline polyester resin is determined from a DSC curve obtained by differential scanning calorimetry (DSC) by the method described in “Melting peak temperature”, which is one method for determining the melting temperature in JIS K 7121-1987 “Testing Methods for Transition Temperatures of Plastics”

The weight average molecular weight (Mw) of the crystalline polyester resin can be 6,000 or more and 35,000 or less.

As with the amorphous polyester resin, the crystalline polyester resin is obtained by a known production method.

From the viewpoints of smoothly forming a crystal structure and improving image fixability achieved by good compatibility with the amorphous polyester resin, the crystalline polyester resin can be a polymer formed between α,ω-linear aliphatic dicarboxylic acid and α,ω-linear aliphatic diol.

As α,ω-linear aliphatic dicarboxylic acid, α,ω-linear aliphatic dicarboxylic acid in which the alkylene group linking the two carboxy groups has 3 to 14 carbon atoms is preferable, and the alkylene group more preferably has 4 to 12 carbon atoms, and yet more preferably has 6 to 10 carbon atoms.

Examples of α,ω-linear aliphatic dicarboxylic acid include succinic acid, glutaric acid, adipic acid, 1,6-hexanedicarboxylic acid (also known as suberic acid), 1,7-heptanedicarboxylic acid (also known as azelaic acid), 1,8-octanedicarboxylic acid (also known as sebacic acid), 1,9-nonandicarboxylic acid, 1,10-decanedicarboxylic acid, 1,12-dodecanedicarboxylic acid, 1,14-tetradecanedicarboxylic acid, and 1,18-octadecanedicarboxylic acid. Among these, 1,6-hexanedicarboxylic acid, 1,7-heptanedicarboxylic acid, 1,8-octanedicarboxylic acid, 1,9-nonanedicarboxylic acid, and 1,10-decanedicarboxylic acid are preferable.

These α,ω-linear aliphatic dicarboxylic acids may be used alone or in combination.

As α,ω-linear aliphatic diol, α,ω-linear aliphatic diol in which the alkylene group linking the two hydroxy groups has 3 to 14 carbon atoms is preferable, and the alkylene group more preferably has 4 to 12 carbon atoms, and yet more preferably has 6 to 10 carbon atoms.

Examples of the α,ω-linear aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, 1,14-tetradecanediol, and 1,18-octadecanediol, and, among these, 1,6-hexanediol, 1,7-heptanediol, 1,8-octanediol, 1,9-nonanediol, and 1,10-decanediol are preferable.

These α,ω-linear aliphatic diols may be used alone or in combination.

From the viewpoints of smoothly forming a crystal structure and improving image fixability achieved by good compatibility with the amorphous polyester resin, the polymer formed between α,ω-linear aliphatic dicarboxylic acid and α,ω-linear aliphatic diol is preferably a polymer formed between at least one selected from the group consisting of 1,6-hexanedicarboxylic acid, 1,7-heptanedicarboxylic acid, 1,8-octanedicarboxylic acid, 1,9-nonanedicarboxylic acid, and 1,10-decanedicarboxylic acid and at least one selected from the group consisting of 1,6-hexanediol, 1,7-heptanediol, 1,8-octanediol, 1,9-nonanediol, and 1,10-decanediol, and is more preferably a polymer formed between 1,10-decanedicarboxylic acid and 1,6-hexanediol.

The crystalline resin preferably accounts for 1 mass % or more and 20 mass % or less, more preferably 2 mass % or more and 15 mass % or less, and yet more preferably 3 mass % or more and 10 mass % or less of the entire binder resin.

### Other Binder Resin

Examples of the binder resin include homopolymers obtained from monomers such as ethylenically unsaturated nitriles (for example, acrylonitrile and methacrylonitrile), vinyl ethers (for example, vinyl methyl ether and vinyl isobutyl ether), vinyl ketones (for example, vinyl methyl ketone, vinyl ethyl ketone, and vinyl isopropenyl ketone), olefines (for example, ethylene, propylene, and butadiene), and copolymers obtained from two or more of these monomers.

Other examples of the binder resin include non-vinyl resins such as epoxy resins, polyurethane resins, polyamide resins, cellulose resins, polyether resins, and modified rosin, mixtures of these non-vinyl resins and the aforementioned vinyl resins, and graft polymers obtained by polymerizing a vinyl monomer in the presence of these resins.

These binder resins may be used alone or in combination.

The binder resin content relative to the entire toner particles is preferably 40 mass % or more and 95 mass % or less, more preferably 50 mass % or more and 90 mass % or less, and yet more preferably 60 mass % or more and 85 mass % or less.

### Releasing Agent

Examples of the releasing agent include hydrocarbon wax; natural wax such as carnauba wax, rice wax, and candelilla wax; synthetic or mineral or petroleum wax such as montan wax; and ester wax such as fatty acid esters and montanic acid esters. The releasing agent is not limited to these.

From the viewpoints of suppressing density nonuniformity and voids in the obtained image, and improving image fixability achieved by good compatibility with the amorphous polyester resin, the releasing agent is preferably an ester wax, and more preferably an ester wax obtained from a higher fatty acid having 10 to 30 carbon atoms and a monohydric or polyhydric alcohol component having 1 to 30 carbon atoms.

The ester wax is a wax having an ester bond. The ester wax may be a monoester, a diester, a triester, or a tetraester, and a known natural or synthetic ester wax can be employed.

Examples of the ester wax include ester compounds formed between higher aliphatic acids (aliphatic acids having 10 or more carbon atoms etc.) and monohydric or polyhydric aliphatic alcohols (aliphatic alcohols having 8 or more carbon atoms etc.) and having a melting point of 60° C. or higher and 110° C. or lower (preferably 65° C. or higher and 100° C. or lower and more preferably 70° C. or higher and 95° C. or lower).

Examples of the ester wax include ester compounds obtained from higher aliphatic acids (caprylic acid, capric acid, lauric acid, myristic acid, palmitic acid, stearic acid, arachidic acid, behenic acid, oleic acid, etc.) and alcohols (monohydric alcohols such as methanol, ethanol, propanol, isopropanol, butanol, capryl alcohol, lauryl alcohol, myristyl alcohol, cetyl alcohol, stearyl alcohol, and oleyl alcohol; and polyhydric alcohols such as glycerin, ethylene glycol, propylene glycol, sorbitol, and pentaerythritol), and specific examples of the ester wax include carnauba wax, rice wax, candelilla wax, jojoba wax, wood wax, beeswax, privet wax, lanolin, and montanic acid ester wax.

The melting temperature of the releasing agent is preferably 50° C. or higher and 110° C. or lower and more preferably 60° C. or higher and 100° C. or lower.

The melting temperature of the releasing agent is determined from a DSC curve obtained by differential scanning calorimetry (DSC) by the method described in “Melting peak temperature”, which is one method for determining the melting temperature in JIS K 7121-1987 “Testing Methods for Transition Temperatures of Plastics”

The releasing agent content relative to the entire toner particles is preferably 1 mass % or more and 20 mass % or less and more preferably 5 mass % or more and 15 mass % or less.

### Coloring Agent

In the first aggregation step, the dispersion can further contain coloring agent particles.

Examples of the coloring agent include various pigments such as carbon black, chrome yellow, hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and dyes such as acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenylmethane dyes, diphenylmethane dyes, and thiazole dyes.

These coloring agents may be used alone or in combination.

The coloring agent may be surface-treated as necessary, or may be used in combination with a dispersing agent. Multiple coloring agents may be used in combination.

The coloring agent content relative to the entire toner particles is, for example, preferably 1 mass % or more and 30 mass % or less and more preferably 3 mass % or more and 15 mass % or less.

### Other Additives

Examples of other additives include known additives such as magnetic materials, charge controllers, and inorganic powders. These additives are contained in the toner particles as internal additives.

### Properties and Other Features of Toner Particles

The toner particles may have a single layer structure or a core-shell structure constituted by a core (core particles) and a coating layer (shell layer) covering the core (core-shell particles). The toner particles having a core-shell structure is constituted by, for example, a core that contains a binder resin and, optionally, a coloring agent, a releasing agent, etc., and a coating layer that contains a binder resin.

In particular, the toner particles are preferably core-shell-type particles from the viewpoints of low-temperature fixability and suppression of color streaks.

The volume average particle diameter (D₅₀ᵥ) of the toner is preferably 2 μm or more and 10 μm or less and more preferably 4 μm or more and 8 μm or less.

The volume average particle diameter of the toner is measured by using Coulter Multisizer II (produced by Beckman Coulter Inc.) with ISOTON-II (produced by Beckman Coulter Inc.) as the electrolyte.

In measurement, 0.5 mg or more and 50 mg or less of a measurement sample is added to 2 mL of a 5 mass % aqueous solution of a surfactant (for example, sodium alkyl benzenesulfonate) serving as the dispersing agent. The resulting mixture is added to 100 mL or more and 150 mL or less of the electrolyte.

The electrolyte in which the sample has been suspended is dispersed for 1 minute with an ultrasonic disperser, and the particle diameter of each of the particles having a diameter in the range of 2 μm or more and 60 μm or less is measured by using Coulter Multisizer II with apertures having an aperture diameter of 100 μm. The number of particles sampled is 50,000.

For the measured particle diameters, a volume-based cumulative distribution is plotted from the small diameter side, and the particle diameter at 50% accumulation is defined as a volume average particle diameter D₅₀ᵥ.

In this exemplary embodiment, the average circularity of the toner particles is not particularly limited; however, from the viewpoint of improving the cleaning property of the toner from the image carrying body, the average circularity is preferably 0.91 or more and 0.98 or less, more preferably 0.94 or more and 0.98 or less, and yet more preferably 0.95 or more and 0.97 or less.

In this exemplary embodiment, the circularity of a toner particle refers to a value of (perimeter of a circle having the same area as the projected image of the particle)/(perimeter of the projected image of the particle), and the average circularity of the toner particles refers to a circularity at 50% accumulation from the smaller side in the circularity distribution. The average circularity of the toner particles is determined by analyzing at least 3,000 toner particles by using a flow particle image analyzer.

The average circularity of the toner particles can be controlled by, for example, adjusting the speed of stirring the dispersion, the temperature of the dispersion, or the retention time of the dispersion in the fusing step.

### External Additive

The toner produced by the method for producing a toner for developing an electrostatic charge image according to this exemplary embodiment can further include an external additive if needed.

Furthermore, the toner produced by the method for producing a toner for developing an electrostatic charge image according to this exemplary embodiment may be toner particles that have no external additives or toner particles with an external additive externally added thereto.

An example of the external additive is inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, and MgSO₄.

The surfaces of the inorganic particles used as an external additive may be hydrophobized. Hydrophobizing involves, for example, dipping inorganic particles in a hydrophobizing agent. The hydrophobizing agent is not particularly limited, and examples thereof include a silane coupling agent, a silicone oil, a titanate coupling agent, and an aluminum coupling agent. These may be used alone or in combination.

The amount of the hydrophobizing agent can be 1 part by mass or more and 10 parts by mass or less relative to 100 parts by mass of the inorganic particles.

Examples of the external additive also include resin particles (resin particles of polystyrene, polymethyl methacrylate (PMMA), melamine resin, and the like) and cleaning active agents (for example, particles of higher aliphatic acid metal salts such as zinc stearate and fluorine polymers).

The external addition amount of the external additive is, for example, preferably 0.01 mass % or more and 10 mass % or less and more preferably 0.01 mass % or more and 6 mass % or less relative to the toner particles.

### Electrostatic Charge Image Developer

The electrostatic charge image developer according to an exemplary embodiment contains at least the toner produced by the method for producing a toner for developing an electrostatic charge image according to the exemplary embodiment.

The electrostatic charge image developer of this exemplary embodiment may be a one-component developer that contains only the toner produced by the method for producing a toner for developing electrostatic charge image according to this exemplary embodiment, or may be a two-component developer that is a mixture of the toner and a carrier.

The carrier is not particularly limited, and examples thereof include known carriers. Examples of the carrier include a coated carrier obtained by covering a surface of a core formed of a magnetic powder with a coating resin; a magnetic powder-dispersed carrier in which a magnetic powder is dispersed and blended in a matrix resin; and a resin-impregnated carrier in which a porous magnetic powder is impregnated with a resin.

The magnetic powder-dispersed carrier and the resin-impregnated carrier may be a carrier constituted by cores covered with a coating resin.

Examples of the magnetic powder include magnetic metals such as iron, nickel, and cobalt, and magnetic oxides such as ferrite and magnetite.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylate copolymer, an organosiloxane bond-containing straight silicone resin and modified products thereof, a fluororesin, polyester, polycarbonate, phenolic resin, and epoxy resin.

The coating resin and the matrix resin may each contain other additives such as conductive particles.

Examples of the conductive particles include particles of metals such as gold, silver, and copper, carbon black, titanium oxide, zinc oxide, tin oxide, barium sulfate, aluminum borate, and potassium titanate.

Here, an example of the method for covering the surface of the core with the coating resin is a method that involves coating the surface of the core with a coating layer-forming solution prepared by dissolving the coating resin and, as necessary, various additives in an appropriate solvent. The solvent is not particularly limited and may be selected by taking into account the coating resin to be used, application suitability, etc.

Specific examples of the resin coating method include a dipping method that involves dipping a core in a coating layer-forming solution, a spraying method that involves spraying a coating layer-forming solution onto the surface of a core, a flow bed method that involves spraying a coating layer-forming solution while the core is floated on flowing air, and a kneader coater method that involves mixing the core formed of a carrier and a coating layer-forming solution in a kneader coater and then removing the solvent.

The toner-to-carrier mixing ratio (mass ratio) of the two-component developer is preferably toner:carrier=1:100 to 30:100 and more preferably 3:100 to 20:100.

### Image Forming Apparatus and Image Forming Method

An image forming apparatus and an image forming method according to this exemplary embodiment will now be described.

The image forming apparatus according to this exemplary embodiment includes an image carrying body, a charging unit that charges a surface of the image carrying body, an electrostatic charge image forming unit that forms an electrostatic charge image on the charged surface of the image carrying body, a developing unit that stores the electrostatic charge image developer and develops the electrostatic charge image on the surface of the image carrying body into a toner image by using the electrostatic charge image developer, a transfer unit that transfers the toner image on the surface of the image carrying body onto a surface of a recording medium, and a fixing unit that fixes the transferred toner image onto the surface of the recording medium. The electrostatic charge image developer of this exemplary embodiment is employed as this electrostatic charge image developer.

The image forming apparatus according to this exemplary embodiment is used to perform an image forming method (the image forming method according to this exemplary embodiment) that includes a charging step of charging a surface of an image carrying body, an electrostatic charge image forming step of forming an electrostatic charge image on the charged surface of the image carrying body, a developing step of developing the electrostatic charge image on the surface of the image carrying body into a toner image by using the electrostatic charge image developer of the exemplary embodiment, a transfer step of transferring the toner image on the surface of the image carrying body onto a surface of a recording medium, and a fixing step of fixing the transferred toner image onto the surface of the recording medium.

A known image forming apparatus is applied as the image forming apparatus of this exemplary embodiment. Examples of the known image forming apparatus include a direct transfer type apparatus with which a toner image formed on a surface of an image carrying body is directly transferred onto a recording medium; an intermediate transfer type apparatus with which a toner image formed on a surface of an image carrying body is first transferred onto a surface of an intermediate transfer body and then the toner image on the intermediate transfer body is transferred for the second time onto a surface of a recording medium; an apparatus equipped with a cleaning unit that cleans the surface of an image carrying body after the toner image transfer and before charging; and an apparatus equipped with a charge erasing unit that irradiates the surface of an image carrying body with charge erasing light to remove charges after the toner image transfer and before charging.

Among these, an image forming apparatus equipped with a cleaning unit that cleans the surface of the image carrying body is suitable. The cleaning unit can be a cleaning blade.

When an intermediate transfer type apparatus is to be employed, the transfer unit is equipped with, for example, an intermediate transfer body having a surface onto which a toner image is transferred, a first transfer unit that transfers the toner image on the surface of the image carrying body onto the surface of the intermediate body, and a second transfer unit that transfers the toner image on the surface of the intermediate transfer body onto a surface of a recording medium.

In the image forming apparatus of this exemplary embodiment, for example, a section that includes the developing unit may have a cartridge structure (process cartridge) that can be attached to and detached from the image forming apparatus. For example, the process cartridge can be equipped with a developing unit that stores the electrostatic charge image developer of the exemplary embodiment.

Hereinafter, one example of the image forming apparatus of the exemplary embodiment is described, but the image forming apparatus is not limited by the description below. The relevant parts illustrated in the drawings are described, and description of other parts is omitted.

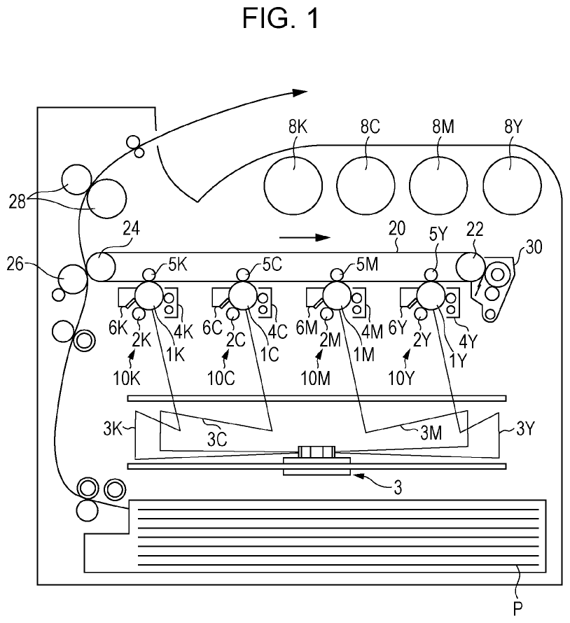

FIG. 1 is a schematic diagram illustrating an image forming apparatus according to an exemplary embodiment.

The image forming apparatus illustrated in FIG. 1 is equipped with first to fourth image forming units 10Y, 10M, 10C, and 10K (image forming units) of an electrophotographic type configured to output images of respective colors, yellow (Y), magenta (M), cyan (C), and black (K), on the basis of the color separated image data. These image forming units (hereinafter may be simply referred to as “units”) 10Y, 10M, 10C, and 10K are disposed side-by-side separated from each other by a predetermined distance in the horizontal direction. These units 10Y, 10M, 10C, and 10K may be process cartridges that can be attached to and detached from the image forming apparatus.

An intermediate transfer belt 20 that serves as an intermediate transfer body for all of the units 10Y, 10M, 10C, and 10K extends above the units 10Y, 10M, 10C, and 10K as viewed in the drawing. The intermediate transfer belt 20 is wound around a drive roll 22 and a support roll 24 that are arranged to be spaced from each other in the left-to-right direction in the drawing. The support roll 24 is in contact with the inner surface of the intermediate transfer belt 20, and the intermediate transfer belt 20 runs in a direction from the first unit 10Y toward the fourth unit 10K. A force that urges the support roll 24 to move in a direction away from the drive roll 22 is applied to the support roll 24 by a spring or the like not illustrated in the drawing so that a tension is applied to the intermediate transfer belt 20 wound around the support roll 24 and the drive roll 22. In addition, an intermediate transfer body cleaning device 30 that faces the drive roll 22 is disposed on the surface of the intermediate transfer belt 20 that carries the images.

Toners of four colors, yellow, magenta, cyan, and black, are stored in toner cartridges 8Y, 8M, 8C, and 8K and supplied to developing devices (developing units) 4Y, 4M, 4C, and 4K of the units 10Y, 10M, 10C, and 10K.

Since the first to fourth units 10Y, 10M, 10C, and 10K are identical in structure, only the first unit 10Y that forms a yellow image and is disposed on the upstream side of the intermediate transfer belt running direction is described as a representative example in the description below. Note that parts equivalent to those of the first unit 10Y are referred by reference signs having magenta (M), cyan (C), or black (K) added thereto instead of yellow (Y) to omit the descriptions of the second to fourth units 10M, 10C, and 10K.

The first unit 10Y has a photoreceptor 1Y that serves as an image carrying body. A charging roll (one example of the charging unit) 2Y that charges the surface of the photoreceptor 1Y to a predetermined potential, the exposing device (one example of the electrostatic charge image forming unit) 3 that forms an electrostatic charge image by exposing the charged surface with a laser beam 3Y on the basis of a color-separated image signal, a developing device (one example of the developing unit) 4Y that develops the electrostatic charge image by supplying the charged toner to the electrostatic charge image, a first transfer roll 5Y (one example of the first transfer unit) that transfers the developed toner image onto the intermediate transfer belt 20, and a photoreceptor cleaning device (one example of the cleaning unit) 6Y that removes the toner remaining on the surface of the photoreceptor 1Y after the first transfer are arranged in the order around the photoreceptor 1Y.

The first transfer roll 5Y is disposed on the inner side of the intermediate transfer belt 20 and faces the photoreceptor 1Y. Furthermore, each of the first transfer rolls 5Y, 5M, 5C, and 5K is connected to a bias power supply (not illustrated) that applies a first transfer bias. The bias power supplies control and vary the transfer biases to be applied to the respective first transfer rolls by controllers not illustrated in the drawing.

Hereinafter, the operation of forming a yellow image in the first unit 10Y is described.

First, prior to the operation, the surface of the photoreceptor 1Y is charged to a potential of −600 V to −800 V by the charging roll 2Y.

The photoreceptor 1Y is formed by forming a photosensitive layer on a conductive (for example, the volume resistivity of 1×10⁻⁶ Ωcm or less at 20° C.) substrate. This photosensitive layer usually has high resistance (resistance of resins in general) but has a property that the part irradiated with a laser beam 3Y undergoes a change in resistivity. Thus the laser beam 3Y is output toward the charged surface of the photoreceptor 1Y through the exposing device 3 according to the yellow image data sent from a controller not illustrated in the drawing. The laser beam 3Y irradiates the photosensitive layer on the surface of the photoreceptor 1Y and thereby forms an electrostatic charge image of a yellow image pattern on the surface of the photoreceptor 1Y.

The electrostatic charge image is an image formed on the surface of the photoreceptor 1Y as a result of charging, and is a so-called negative latent image formed by the charges remaining in the portion of the photosensitive layer not irradiated with the laser beam 3Y as the charges on the surface of the photoreceptor 1Y in the portion of the photosensitive layer irradiated with the laser beam 3Y flow due to the decreased resistivity of the irradiated portion.

The electrostatic charge image on the photoreceptor 1Y is rotated to a predetermined development position as the photoreceptor 1Y is run. Then at this development position, the electrostatic charge image on the photoreceptor 1Y is visualized (developed image) into a toner image by the developing device 4Y.

For example, an electrostatic charge image developer that contains at least a yellow toner and a carrier is stored in the developing device 4Y. The yellow toner is frictionally charged by being stirred in the developing device 4Y and is carried on a developer roll (an example of a developer carrying member) by having charges of the same polarity (negative polarity) as the charges on the photoreceptor 1Y. Then as the surface of the photoreceptor 1Y passes the developing device 4Y, the yellow toner electrostatically adheres to the latent image portion from which the charges on the surface of the photoreceptor 1Y have been removed, and thus the latent image is developed with the yellow toner. The photoreceptor 1Y on which the yellow toner image has been formed is continuously run at a predetermined speed, and the toner image developed on the photoreceptor 1Y is conveyed to a predetermined first transfer position.

As the yellow toner image on the photoreceptor 1Y is conveyed to the first transfer position, a first transfer bias is applied to the first transfer roll 5Y, an electrostatic force acting from the photoreceptor 1Y toward the first transfer roll 5Y acts on the toner image, and the toner image on the photoreceptor 1Y is transferred onto the intermediate transfer belt 20. The transfer bias applied here has a polarity (+) opposite of the polarity (−) of the toner, and, for example, the transfer bias is controlled to +10 μA by a controller (not illustrated) in the first unit 10Y.

Meanwhile, the toner remaining on the photoreceptor 1Y is removed and recovered by the photoreceptor cleaning device 6Y.

The first transfer biases applied to the first transfer rolls 5M, 5C, and 5K of the second unit 10M and onward are controlled in accordance with the first unit.

As such, the intermediate transfer belt 20 onto which the yellow toner image has been transferred in the first unit 10Y is sequentially conveyed through the second to fourth units 10M, 10C, and 10K, and toner images of respective colors are superimposed on each other (multiple transfer).

The intermediate transfer belt 20 onto which the toner images of four colors have been transferred through the first to fourth units reaches a second transfer section constituted by the intermediate transfer belt 20, the support roll 24 in contact with the inner surface of the intermediate transfer belt 20, and a second transfer roll (one example of the second transfer unit) 26 disposed on the image-carrying surface-side of the intermediate transfer belt 20. Meanwhile, a supplying mechanism supplies a recording sheet (one example of the recording medium) P, at a predetermined timing, to a gap between the second transfer roll 26 and the intermediate transfer belt 20 in contact with each other, and a second transfer bias is applied to the support roll 24. The transfer bias applied at this stage has the same polarity (−) as the polarity (−) of the toner, and an electrostatic force acting from the intermediate transfer belt 20 toward the recording sheet P acts on the toner image, and the toner image on the intermediate transfer belt is transferred onto the recording sheet P. Here, the second transfer bias is determined on the basis of the resistance detected with a resistance detection unit (not illustrated) that detects the resistance of the second transfer section, and is voltage-controlled.

Subsequently, the recording sheet P is sent into a contact section (nip section) between a pair of fixing rolls of a fixing device (one example of the fixing unit) 28, and the toner image is fixed onto the recording sheet P to form a fixed image.

Examples of the recording sheet P used to transfer the toner image include regular paper used in electrophotographic copier and printers, etc. The recording medium may be OHP sheets and the like instead of the recording sheet P.

In order to further improve the smoothness of the image surface after fixing, the surface of the recording sheet P can also be smooth, and examples of such a recording sheet P include coated paper obtained by coating the surface of regular paper with a resin or the like, and art paper used in printing.

The recording sheet P after completion of fixing of the color image is conveyed toward a discharge section, thereby ending a series of color image forming operations.

### Process Cartridge and Toner Cartridge

A process cartridge according to an exemplary embodiment will now be described.

The process cartridge of this exemplary embodiment is equipped with a developing unit that stores the electrostatic charge image developer of the exemplary embodiment and develops an electrostatic charge image on the surface of an image carrying body into a toner image by using the electrostatic charge image developer, and is detachably attachable to an image forming apparatus.

The process cartridge of this exemplary embodiment is not limited to the aforementioned structure, and may be have a structure that includes a developing device and, if needed, at least one selected from other units, for example, an image carrying body, a charging unit, an electrostatic charge image forming unit, and a transfer unit.

Hereinafter, one example of the process cartridge according to the exemplary embodiment is described, but the process cartridge is not limited by the description below. The relevant parts illustrated in the drawings are described, and description of other parts is omitted.

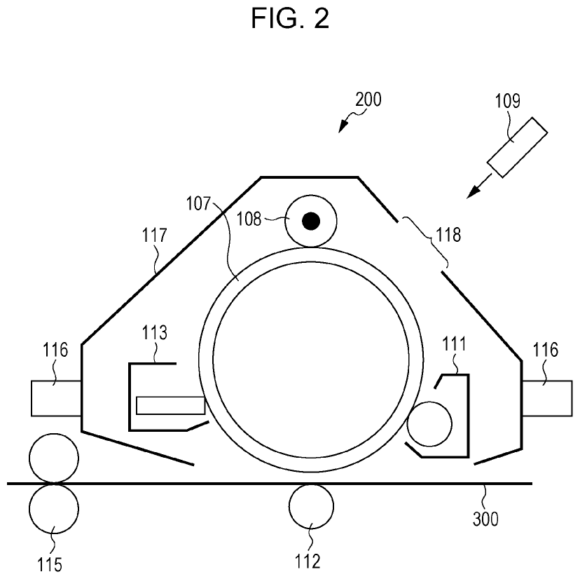

FIG. 2 is a schematic diagram illustrating a process cartridge of an exemplary embodiment.

A process cartridge 200 illustrated in FIG. 2 is constituted by a casing 117 equipped with a guide rail 116 and an opening 118 for exposure, the casing integrating a photoreceptor 107 (one example of the image carrying body), a charging roll 108 (one example of the charging unit) disposed around the photoreceptor 107, a developing unit 111 (one example of the developing unit), and a photoreceptor cleaning unit 113 (one example of the cleaning unit) to form a cartridge.

Note that in FIG. 2, 109 denotes an exposure device (one example of the electrostatic charge image forming unit), 112 denotes a transfer device (one example of the transfer unit), 115 denotes a fixing device (one example of the fixing unit), and 300 denotes a recording sheet (one example of the recording medium).

Next, a toner cartridge according to an exemplary embodiment is described.

The toner cartridge of this exemplary embodiment stores the toner of the exemplary embodiment and is detachably attachable to an image forming apparatus. The toner cartridge stores replenishment toner to be supplied to the developing unit in the image forming apparatus.

The image forming apparatus illustrated in FIG. 1 is of a type that the toner cartridges 8Y, 8M, 8C, and 8K are detachably attachable, and the developing devices 4Y, 4M, 4C, and 4K are respectively connected to the toner cartridges corresponding to the respective developing devices (colors) through toner supply tubes. Moreover, when the toner in the toner cartridge runs low, the toner cartridge is replaced.

### EXAMPLES

Hereinafter the exemplary embodiments are specifically described in details through examples and comparative examples which do not limit the scope of the exemplary embodiments. Note that the “parts” and “%” indicating amounts are on a mass basis unless otherwise noted.

### Synthesis of Polyester Resin

Into a reactor equipped with a stirrer, a thermometer, a condenser, and a nitrogen gas inlet tube, 80 mol parts of polyoxypropylene (2,2)-2,2-bis(4-hydroxyphenyl)propane, 10 mol parts of ethylene glycol, 10 mol parts of cyclohexanediol, 80 mol parts of terephthalic acid, 10 mol parts of isophthalic acid, and 10 mol parts of n-dodecenyl succinic acid are placed, and the inside of the reactor is purged with dry nitrogen gas. Next, 0.25 parts by mass of titanium tetrabutoxide serving as a catalyst is added relative to 100 parts by mass of the aforementioned monomer components. Under a nitrogen gas stream, the reaction is conducted at 170° C. for 3 hours while stirring, the temperature is then further elevated to 210° C. over the period of 1 hour, the inside of the reactor is depressurized to 3 kPa, and the reaction is performed at a reduced pressure for 13 hours while stirring to obtain a polyester resin. The obtained resin is analyzed with a differential scanning calorimeter (DSC) to measure the glass transition temperature of the resin, and the glass transition temperature is found to be 58° C.

### Preparation of Polyester Resin Particle Dispersion

polyester resin described above: 100 parts by mass
ethyl acetate: 70 parts by mass
isopropyl alcohol: 15 parts by mass

Into a jacketed stainless steel container, a mixed solvent of ethyl acetate and isopropyl alcohol described above is placed, and the polyester resin is gradually added thereto and completely dissolved while stirring to obtain an oil phase. To the oil phase under stirring, a total of 3 parts by mass of a 10 mass % ammonia aqueous solution is gradually added dropwise through a pump, and then 230 parts by mass of ion exchange water is gradually added dropwise at a rate of 10 L/min to perform phase inversion emulsification. Subsequently, vacuum distillation is performed to obtain a polyester resin particle dispersion (solid component concentration: 40 mass %). The solid component concentration is measured with moisture meter MA35 (produced by Sartorius Mechatronics Japan K.K.). The solid component concentration of each of the samples below is also measured in the same manner.

The volume average particle diameter (D50v) of the polyester resin particles in the obtained polyester resin particle dispersion is 180 nm. The volume average particle diameter of the polyester resin particles is measured with a laser diffraction particle size distribution meter (LA-700: produced by Horiba Ltd.). The measurement method involves preparing a sample in a dispersed state with a solid content of about 2 g, adding ion exchange water to the sample to adjust the volume to about 40 mL, adding the sample to a cell until an appropriate concentration is reached, waiting 2 minutes to stabilize the concentration in the cell, and performing measurement. The volume average particle diameter for each of the obtained particle size ranges (channels) is accumulated from the smaller volume average particle diameter side, and the value at 50% accumulation is assumed to be the volume average particle diameter (D50v).

### Preparation of Styrene Acrylic Resin Dispersion

styrene: 77 parts
n-butyl acrylate: 23 parts
1,10-decanediol diacrylate: 0.4 parts
dodecanethiol: 0.7 parts

The aforementioned materials are mixed and dissolved, and a solution prepared by dissolving 1.0 part of an anionic surfactant (DOWFAX produced by Dow Chemical Company) in 60 parts of ion exchange water is added thereto. The resulting mixture is dispersed and emulsified in a flask to prepare an emulsion of monomers. Next, 2.0 parts of an anionic surfactant (DOWFAX produced by Dow Chemical Company) is dissolved in 90 parts of ion exchange water, 2.0 parts of the emulsion of monomers is added thereto, and 10 parts of ion exchange water in which 1.0 part of ammonium sulfate is dissolved is added to the resulting mixture. Next, the remainder of the emulsion of monomers is added thereto over a period of 3 hours, the inside of the flask is purged with nitrogen, the solution in the flask is heated on an oil bath until 75° C. while stirring, and the emulsification polymerization is continued under such conditions for 5 hours. As a result, a styrene acrylic resin particle dispersion is obtained. Ion exchange water is added to the styrene acrylic resin particle dispersion to adjust the solid content to 40%. The volume average particle diameter (D50v) of the particles in the styrene acrylic resin particle dispersion is 160 nm.

### Preparation of Releasing Agent Particle Dispersion 1

paraffin wax (FNP92 produced by produced by Nippon Seiro Co., Ltd., endothermic peak onset: 81° C.): 45 parts
anionic surfactant (NEOGEN RK produced by DKS Co., Ltd.): 5 parts
ion exchange water: 200 parts

The aforementioned materials are mixed and heated to 95° C. The resulting mixture is dispersed by using a homogenizer (ULTRA-TURRAX T50 produced by IKA Japan). The resulting dispersion is then dispersed in a Manton-Gaulin high-pressure homogenizer (produced by Gaulin Company) to prepare a releasing agent particle dispersion (solid component concentration: 20%) containing a dispersed releasing agent. The volume average particle diameter of the releasing agent particles is 0.19 μm.

### Preparation of Releasing Agent Particle Dispersion 2

A releasing agent particle dispersion 2 is obtained as with the method for preparing the releasing agent particle dispersion 1 except that the paraffin wax is changed to carnauba wax (RC160 produced by TOA KASEI CO., LTD., endothermic peak onset: 85° C.). The volume average particle diameter of the obtained releasing agent particles is 0.21 μm.

### Preparation of Coloring Agent Particle Dispersion

cyan pigment (Pigment Blue 15:3 (copper phthalocyanine) produced by Dainichiseika Color & Chemicals Mfg. Co.): 98 parts
anionic surfactant (NEOGEN R produced by DKS Co., Ltd.): 2 parts
ion exchange water: 400 parts

The aforementioned materials are mixed and dissolved, and the resulting mixture is dispersed for 10 minutes by using a homogenizer (IKA ULTRA-TURRAX) to obtain a coloring agent particle dispersion having a center particle diameter of 0.16 μm and a solid content of 20%.

### Example 1

### Preparation of Toner Particles 1

polyester resin particle dispersion: 450 parts
releasing agent particle dispersion 1: 50 parts
coloring agent particle dispersion: 45 parts
ion exchange water: 600 parts
anionic surfactant (DOWFAX 2A1 produced by Dow Chemical Company): 2.2 parts

While the aforementioned components are mixed and dispersed in a 3 L reactor equipped with a thermometer, a pH meter, and a stirrer by using the stirrer and a homogenizer (ULTRA-TURRAX T50 produced by IKA Japan), 100 parts of an aqueous aluminum sulfate solution having a concentration of 1.0% is added thereto as an aggregating agent at a temperature of 25° C., and mixing and dispersing are continued for 10 minutes. Next, after the pH in the system is adjusted to 3.0 by adding 1.0% nitric acid, a heating mantle is installed to the reactor, and the mixture is heated and retained at 45° C. for 60 minutes while adjusting the rotation speed of the stirrer to thoroughly stir the mixture. As a result, a dispersion A is obtained. To the dispersion A, 250 parts by mass of a polyester resin particle dispersion (dispersion B) having the pH and the temperature respectively adjusted to 4.2 and 18° C. is gradually added, and the resulting mixture is retained for 30 minutes to prepare second aggregated particles having a core-shell structure. Subsequently, 8 parts of a 20% solution of ethylenediaminetetraacetic acid (EDTA) is added to the reactor, and then 60 mmol of a 1 mol/L aqueous sodium hydroxide solution per kilogram of the toner is added thereto to control the pH inside the system to 7.4 and to terminate the aggregation. Subsequently, while heating at a temperature elevation rate of 1° C./minute up to 90° C., a 1 mol/L aqueous sodium hydroxide solution is added each time the temperature is elevated 12° C. for a total of three times in a total amount of 45 mmol, and then the resulting mixture is retained for 2 hours. The pH of the dispersion when the fusing temperature is reached is 7.8. After completion of heating and retaining, the container is cooled with cooling water to 30° C. over a period of 5 minutes, and the cooled slurry is passed through a nylon mesh having 15 μm openings to remove coarse particles. Then ion exchange water is passed through the filtrate until the electrical conductivity reaches 10 μS/cm or less while performing solid-liquid separation by Nutsche suction filtration to wash the filtrate. The washed solid cake is finely pulverized with a wet-dry-type particle sizer (Comil), and vacuum freeze drying is continued for 24 hours to obtain toner particles 1.

### Preparation of Toner 1

To 1100 parts by mass of the obtained toner particles, 1.5 parts by mass of hydrophobic silica (RY 50 produced by Nippon Aerosil Co., Ltd., number-average particle diameter: 140 nm) is mixed and blended by using a sample mill at 10,000 rpm for 30 seconds. Subsequently, the resulting product is sieved through a vibrating sieve having 45 μm openings to prepare a toner 1 (toner for developing an electrostatic charge image). The volume average particle diameter of the obtained toner 1 is 4.0 μm.

### Preparation of Carrier

After 500 parts of spherical magnetite powder particles (volume average particle diameter: 0.55 μm) are thoroughly stirred in a HENSCHEL mixer, 5.0 parts of a titanate coupling agent is added, and the resulting mixture is heated to 100° C. and then mixed and stirred for 30 minutes to obtain titanate coupling agent-coated spherical magnetite particles.

Subsequently, into a four-necked flask, 6.25 parts of phenol, 9.25 parts of 35% formalin, 500 parts of the aforementioned magnetite particles, 6.25 parts of a 25% ammonia water, and 425 parts of water are placed, and the resulting mixture is mixed and stirred. Next, after performing the reaction at 85° C. for 120 minutes while stirring, the mixture is cooled to 25° C., 500 parts of water is added thereto, the supernatant is removed, and the deposits are washed with water. The washed deposits are dried at 150° C. or higher and 180° C. or lower at a reduced pressure to obtain a carrier having an average particle diameter of 35 μm.

### Preparation of Electrostatic Charge Image Developer 1

The obtained carrier and the toner 1 are placed in a V blender at a toner-to-carrier ratio of 5:95 (mass ratio), and the resulting mixture is stirred for 20 minutes to obtain an electrostatic charge image developer 1.

### Examples 2 to 9 and Comparative Examples 1 to 3

Toners and electrostatic charge image developers are prepared as in Example 1 except that the total amount of the basic compound added from the time aggregation starts to terminate in the second aggregation step to the time the temperature is elevated to the fusion temperature in the fusing step and that the dispersion pH(A) and the dispersion pH(B) are changed as indicated in Table.

### Example 10

A toner and an electrostatic charge image developer are prepared as in Example 1 except that the 1 mol/L aqueous sodium hydroxide solution added after preparation of the second aggregated particles is added in fractions twice and that the total amount of the basic compound, the dispersion pH(A), and the dispersion pH(B) are changed as indicated in Table.

### Example 11

A toner and an electrostatic charge image developer are prepared as in Example 1 except that the 1 mol/L aqueous sodium hydroxide solution is added each time the temperature is elevated 10° C. for a total of four times until the fusion temperature is reached and that the total amount of the basic compound, the dispersion pH(A), and the dispersion pH(B) are changed as indicated in Table.

### Example 12

A toner and an electrostatic charge image developer are prepared as in Example 1 except that the polyester resin particle dispersion used in the dispersion A is changed to a styrene acrylic resin particle dispersion and that the total amount of the basic compound, the dispersion pH(A), and the dispersion pH(B) are changed as indicated in Table.

### Example 13

A toner and an electrostatic charge image developer are prepared as in Example 1 except that the polyester resin particle dispersion used in the dispersion B is changed to a styrene acrylic resin particle dispersion and that the total amount of the basic compound, the dispersion pH(A), and the dispersion pH(B) are changed as indicated in Table.

### Example 14

A toner and an electrostatic charge image developer are prepared as in Example 1 except that the releasing agent particle dispersion 1 used in the dispersion A is changed to a releasing agent particle dispersion 2 and that the total amount of the basic compound, the dispersion pH(A), and the dispersion pH(B) are changed as indicated in Table.

### Example 15

A toner and an electrostatic charge image developer are prepared as in Example 1 except that the amount of the 20% solution of ethylenediaminetetraacetic acid (EDTA) added after preparation of the second aggregated particles is changed to 16 parts and that that the total amount of the basic compound, the dispersion pH(A), and the dispersion pH(B) are changed as indicated in Table.

### Example 16

A toner and an electrostatic charge image developer are prepared as in Example 1 except that the aqueous sodium hydroxide solution added after preparation of the second aggregated particles and during the period up to reaching the fusing temperature is changed to a powder of sodium hydroxide and that that the total amount of the basic compound, the dispersion pH(A), and the dispersion pH(B) are changed as indicated in Table.

### Measurement of Toner Particle Size Distribution

The particle size distribution of the toner is measured by using a Coulter particle size analyzer (for example, Coulter Multisizer II produced by Beckman Coulter Inc.). Specifically, the particle size distribution is measured according to the following procedure.

First, 0.5 mg or more and 50 mg or less of the toner is mixed with 2 mL of a 5 mass % aqueous solution of a surfactant (for example, sodium alkyl benzene sulfonate) and then with 100 mL or more and 150 mL or less of an electrolyte (for example, ISOTON-II produced by Beckman Coulter Inc.), and the resulting mixture is dispersed with an ultrasonic disperser for 1 minute to prepare a dispersion. This dispersion is used as a measurement sample, and the particle diameters of 50,000 particles having a particle diameter of 2 μm or more and 60 μm or less are measured with a Coulter particle size distribution analyzer with a 100 μm aperture. The particle size distribution of the 50,000 particles is plotted from the small diameter side on a volume basis, and the particle diameter at 50% accumulation is defined as a volume-average particle diameter D50v and the particle diameter at 84% accumulation is defined as D84v. The particle size distribution of the toner of the exemplary embodiment is the upper volume-average particle size distribution index (upper GSDv) and is calculated from upper GSDv=D84v/D50v.

### Evaluation of Property of Suppressing Generation of Coarse Particles

The water dispersion containing 100 g of the toner is sieved through a sieve having 10 μm openings, the oversieve is dried, and the coarse particle content in the toner is calculated.

A: The coarse particle content is less than 2 mass %. Generation of coarse particles is little, and the property is excellent.

B: The coarse particle content is less than 2 mass % or more and less than 5 mass %, and a small quantity of coarse particles are generated.

C: The coarse particle content is 5 mass % or more, and a large quantity of coarse particles are generated.

A and B are acceptable.

### Evaluation of Property of Suppressing Image Defects

A modified model obtained by placing the obtained electrostatic charge image developer into a developing device of DocuCenter Color 400 (produced by Fuji Xerox Co., Ltd.) is left to stand in a high-temperature, high-humidity environment having a temperature of 30° C. and a relative humidity of 90%, and a test charge having an image area ratio of 100% is continuously output on 1,000 sheets of A4 regular paper. The image on the 1,000th sheet is observed with naked eye and through a magnifying glass, and evaluation is performed under the following evaluation condition.

A: No voids are found under observation with naked eye and through a magnifying glass.

B: No voids are found under observation with naked eye but minor voids are found under observation through a magnifying glass.

C: Minor voids are observed under observation with naked eye.

D: An unacceptable level of voids are observed under observation with naked eye.

The evaluation results are all indicated in Table.

TABLE

| | | | | | Total | | | | | Property of | |
|---|---|---|---|---|---|---|---|---|---|---|---|
| | Added | Added | | | amount | | | | Particle size | suppressing | |
| | amount | amount | | | of basic | | | | distribution | generation | Property of |
| | A | B | | | compound | pH(B) − | D50v | D84v | of toner | of coarse | suppressing |
| | (mmol) | (mmol) | pH(A) | pH(B) | (mmol) | pH(A) | (μm) | (μm) | Upper GSDv | particles | image defects |
| Example 1 | 60 | 45 | 7.4 | 7.8 | 105 | 0.4 | 4.0 | 4.7 | 1.17 | A | A |
| Example 2 | 30 | 15 | 7.3 | 7.4 | 45 | 0.1 | 4.5 | 5.4 | 1.21 | C | C |
| Example 3 | 45 | 30 | 7.5 | 7.7 | 75 | 0.2 | 4.3 | 5.2 | 1.20 | B | B |
| Example 4 | 90 | 50 | 8.0 | 8.6 | 140 | 0.6 | 4.4 | 5.2 | 1.18 | A | B |
| Example 5 | 50 | 130 | 7.2 | 8.9 | 180 | 1.7 | 4.2 | 5.1 | 1.21 | C | C |
| Example 6 | 25 | 20 | 7.3 | 7.2 | 45 | −0.1 | 4.1 | 4.9 | 1.20 | C | C |
| Example 7 | 40 | 50 | 7.5 | 7.7 | 90 | 0.2 | 4.5 | 5.4 | 1.20 | A | B |
| Example 8 | 100 | 80 | 7.7 | 8.8 | 180 | 1.1 | 4.3 | 5.1 | 1.19 | A | B |
| Example 9 | 15 | 165 | 6.8 | 9.2 | 180 | 2.4 | 4.1 | 5.0 | 1.21 | C | C |
| Example 10 | 75 | 55 | 7.4 | 8.2 | 130 | 0.8 | 4.2 | 5.0 | 1.20 | B | B |
| Example 11 | 65 | 50 | 7.2 | 7.8 | 115 | 0.6 | 4.1 | 4.9 | 1.19 | A | B |
| Example 12 | 55 | 40 | 7.0 | 7.3 | 95 | 0.3 | 4.1 | 4.9 | 1.20 | A | B |
| Example 13 | 65 | 65 | 7.4 | 8.0 | 130 | 0.6 | 4.4 | 5.3 | 1.20 | B | B |
| Example 14 | 80 | 75 | 7.5 | 8.5 | 155 | 1.0 | 4.2 | 5.1 | 1.21 | B | B |
| Example 15 | 45 | 45 | 7.1 | 7.5 | 90 | 0.4 | 4.4 | 5.3 | 1.21 | B | B |
| Example 16 | 65 | 55 | 7.1 | 7.9 | 120 | 0.8 | 4.0 | 4.8 | 1.20 | B | B |
| Comparative | 80 | 120 | 7.4 | 9.5 | 200 | 2.1 | 3.7 | 4.5 | 1.22 | C | D |
| Example 1 | | | | | | | | | | | |
| Comparative | 30 | 170 | 6.4 | 9.7 | 200 | 3.3 | 3.8 | 4.7 | 1.23 | C | D |
| Example 2 | | | | | | | | | | | |
| Comparative | 30 | 5 | 6.9 | 6.8 | 35 | −0.1 | 4.0 | 5.0 | 1.24 | C | D |
| Example 3 | | | | | | | | | | | |

In Table, the “added amount A” indicates the amount, per kilogram of toner particles to be obtained, of the basic compound added when terminating the aggregation in the second aggregation step, the “added amount B” indicates the amount, per kilogram of toner particles to be obtained, of the basic compound added when elevating the temperature in the fusing step, “pH(A)” indicates the pH of the dispersion in upon termination of the aggregation in the second aggregation step, “pH(B)” indicates the pH of the dispersion upon elevation of the temperature to the fusion temperature in the fusing step, “total amount of basic compound” indicates the total amount, per kilogram of toner particles to be obtained, of the basic compound added from the time aggregation starts to terminate in the second aggregation step to the time the temperature is elevated to the fusion temperature in the fusing step.

These results show that the toners for developing an electrostatic charge image of Examples have narrower particle size distributions than Comparative Examples.

The results also show that in Examples, a toner for developing an electrostatic charge image, the toner having an excellent property of suppressing generation of coarse particles and an excellent property of suppressing image defects, is obtained.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A method for producing a toner for developing an electrostatic charge image, comprising:
performing first aggregation that involves aggregating at least resin particles and releasing agent particles contained in a dispersion to prepare a dispersion A containing first aggregated particles;
performing second aggregation that involves adding a dispersion B containing shell resin particles to the dispersion A and aggregating the shell resin particles to form second aggregated particles; and
heating and fusing the second aggregated particles to form fused particles,
wherein a total of 40 mmol or more and 190 mmol or less of a basic compound is added, per kilogram of toner particles to be obtained, from a time aggregation starts to terminate in the second aggregation to a time a temperature is elevated to a fusion temperature in the heating and fusing.

2. The method for producing a toner for developing an electrostatic charge image according to claim 1, wherein, when a pH of a dispersion upon termination of aggregation in the second aggregation is represented by pH(A) and a pH of a dispersion upon elevation of the temperature to the fusion temperature in the heating and fusing is represented by pH(B), pH(B)−pH(A) is more than 0 and less than 2.

3. The method for producing a toner for developing an electrostatic charge image according to claim 2, wherein pH(B)−pH(A) is more than 0 and less than 1.

4. The method for producing a toner for developing an electrostatic charge image according to claim 1, wherein the basic compound is added at least once when terminating aggregation in the second aggregation.

5. The method for producing a toner for developing an electrostatic charge image according to claim 2, wherein the basic compound is added at least once when terminating aggregation in the second aggregation.

6. The method for producing a toner for developing an electrostatic charge image according to claim 3, wherein the basic compound is added at least once when terminating aggregation in the second aggregation.

7. The method for producing a toner for developing an electrostatic charge image according to claim 4, wherein the basic compound is added at least once when elevating the temperature in the heating and fusing.

8. The method for producing a toner for developing an electrostatic charge image according to claim 5, wherein the basic compound is added at least once when elevating the temperature in the heating and fusing.

9. The method for producing a toner for developing an electrostatic charge image according to claim 6, wherein the basic compound is added at least once when elevating the temperature in the heating and fusing.

10. The method for producing a toner for developing an electrostatic charge image according to claim 1, wherein the resin particles aggregated in the first aggregation are polyester resin particles.

11. The method for producing a toner for developing an electrostatic charge image according to claim 2, wherein the resin particles aggregated in the first aggregation are polyester resin particles.

12. The method for producing a toner for developing an electrostatic charge image according to claim 3, wherein the resin particles aggregated in the first aggregation are polyester resin particles.

13. The method for producing a toner for developing an electrostatic charge image according to claim 4, wherein the resin particles aggregated in the first aggregation are polyester resin particles.

14. The method for producing a toner for developing an electrostatic charge image according to claim 5, wherein the resin particles aggregated in the first aggregation are polyester resin particles.

15. The method for producing a toner for developing an electrostatic charge image according to claim 6, wherein the resin particles aggregated in the first aggregation are polyester resin particles.

16. The method for producing a toner for developing an electrostatic charge image according to claim 7, wherein the resin particles aggregated in the first aggregation are polyester resin particles.

17. The method for producing a toner for developing an electrostatic charge image according to claim 8, wherein the resin particles aggregated in the first aggregation are polyester resin particles.

18. The method for producing a toner for developing an electrostatic charge image according to claim 1, wherein the shell resin particles are polyester resin particles.

19. The method for producing a toner for developing an electrostatic charge image according to claim 1, wherein the addition of the basic compound involves adding an aqueous solution of the basic compound.

20. A toner for developing an electrostatic charge image, the toner being obtained by a method for producing a toner for developing an electrostatic charge image according to claim 1.
